(19) United States
(12) Patent Application Publication
(10) Pub. No.: US 2026/0218012 A1
(43) Pub. Date: Jul. 30, 2026

(54) ASPHALT COMPOSITION FOR ROOFING APPLICATIONS

(71) Applicant: CERTAINTEED LLC, Malvern, PA (US)

(72) Inventors: Dong TIAN, Lancaster, PA (US); Jun YAN, Malvern, PA (US); Francis BOSSÉ, Terrebonne (CA); Amirmohammad BAHADORI, Malvern, PA (US); Mingxin LI, Malvern, PA (US)

(21) Appl. No.: 19/461,839

(22) Filed: Jan. 28, 2026

Related U.S. Application Data
(60) Provisional application No. 63/750,498, filed on Jan. 28, 2025.

(51) Int. Cl. C09D 195/00; E04D 1/20

(52) U.S. Cl. CPC C09D 195/00; E04D 1/20

(57) ABSTRACT

According to one aspect, an asphalt blend can include:
70-99.5 wt. % an oxidized asphalt;
0.5-20 wt. % of an oxidized asphalt extender; and
0.5-15 wt. % asphalt flux.

According to a second aspect, an asphalt blend can include an overoxidized asphalt and an asphalt flux.

A fire resistant shingle can be prepared by coating a fiberglass mat with the aforementioned blend.

### CROSS-REFERENCE TO RELATED APPLICATION(S)

This application claims priority under 35 U.S.C. § 119(e) to U.S. Provisional Patent Application No. 63/750,498, entitled “ASPHALT COMPOSITION FOR ROOFING APPLICATIONS,” filed Jan. 28, 2025, by Dong TIAN et al., which is assigned to the current assignee hereof and is incorporated herein by reference in its entirety.

### BACKGROUND

### Field of the Disclosure

The following is directed to asphalt compositions, and more particularly, filled asphalt mixes for roofing applications.

### SUMMARY

According to one aspect, an asphalt blend can include:
70-99.5 wt. % an oxidized asphalt;
0.5-20 wt. % of an oxidized asphalt extender; and
0.5-15 wt. % asphalt flux.

According to a second aspect, an asphalt blend can include an overoxidized asphalt and an asphalt flux.

A fire-resistant shingle can be prepared by coating a fiberglass mat with the aforementioned blend.

### BRIEF DESCRIPTION OF THE DRAWINGS

The present disclosure may be better understood, and its numerous features and advantages made apparent to those skilled in the art by referencing the accompanying drawings.

FIG. 1 includes a process for preparing a filled asphalt mix.

FIG. 2 includes a temperature profile for DSC testing.

### DETAILED DESCRIPTION

As used herein, “asphalt flux” refers to an asphalt with a penetration at 77° F. of 120-400 dmm. Asphalt flux has not been subject to an oxidation or air blowing process.

As used herein, “low pen asphalt flux” refers to an asphalt with a penetration at 77° F. of 120-200. Low pen asphalt flux has not been subject to an oxidation or air blowing process.

As used herein, “oxidized asphalt” refers to an asphalt flux that has been blown or oxidized to a softening point of no greater than 235, typical for roofing asphalt.

As used herein, “overoxidized asphalt” refers to an asphalt flux that has been blown or oxidized to a softening point of at least 235, above what is often targeted for roofing asphalt.

As used herein an asphalt extender refers a low viscosity oil or semisolid used to improve properties of an asphalt mix or blend.

As used herein a vacuum tower asphalt extender or re-refined engine oil bottoms refers to non-distillable residuum from a vacuum tower in a used oil re-refinery.

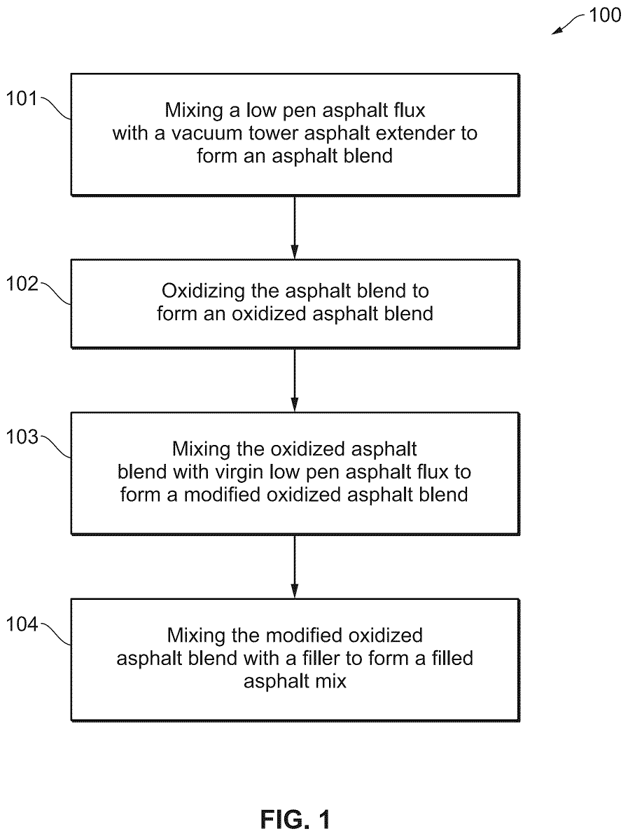

The following is directed to asphalt compositions. According to a first aspect, a process for preparing a filled asphalt mix 100 is shown in FIG. 1.

The process can begin with step 101, mixing an asphalt flux with an asphalt extender to form an asphalt blend.

In an embodiment, the asphalt blend may have a particular asphalt flux content that may facilitate improved performance and/or manufacturing of the asphalt blend or roofing materials prepared therefrom. In an embodiment, the asphalt blend may comprise at least 70 wt. % al asphalt flux for a total weight of the asphalt blend or at least 71 wt. % or at least 22 wt. % or at least 73 wt. % or at least 74 wt. % or at least 75 wt. % or at least 76 wt. % or at least 77 wt. % or at least 78 wt. % or at least 79 wt. % or at least 80 wt. % or at least 81 wt. % or at least 82 wt. % or at least 83 wt. % or at least 84 wt. % or at least 85 wt. % or at least 86 wt. % or at least 87 wt. % or at least 88 wt. % or at least 89 wt. % or at least 90 wt. %. In another embodiment, the asphalt blend may comprise no greater than 99.5 wt. % asphalt flux for a total weight of the asphalt blend or no greater than 99 wt. % or no greater than 98 wt. % or no greater than 97 wt. % or no greater than 96 wt. % or no greater than 95 wt. %. It will be appreciated that the asphalt flux content may be between any of the minimum and maximum values noted above, including for example, but not limited to at least 70 wt. % and not greater than 99.5 wt. % or at least 80 wt. % and not greater than 95 wt. %. The asphalt flux may be a low pen asphalt flux.

In an embodiment, the asphalt extender may have a particular composition that may facilitate improved performance and/or manufacturing of the asphalt blend or mix or roofing materials prepared therefrom. In an embodiment, the asphalt extender may comprise wax, vacuum tower asphalt extender, re-refined engine oil bottoms, bio-oil, process oil, or combinations thereof. In an embodiment, the asphalt extender may comprise vacuum tower asphalt extender or re-refined engine oil bottoms.

In an embodiment, the asphalt blend may have a particular asphalt extender content that may facilitate improved performance and/or manufacturing of the asphalt blend or roofing materials prepared therefrom. In an embodiment, the asphalt blend may comprise at least 0.5 wt. % of an asphalt extender for a total weight of the asphalt blend or at least 1 wt. % or at least 2 wt. % or at least 3 wt. % or at least 4 wt. % or at least 5 wt. % or at least 6 wt. %. In another embodiment, the asphalt blend may comprise no greater than 30 wt. % asphalt extender for a total weight of the asphalt blend or no greater than 28 wt. % or no greater than 26 wt. % or no greater than 24 wt. % or no greater than 22 wt. % or no greater than 20 wt. % or no greater than 18 wt. % or no greater than 16 wt. % or no greater than 14 wt. % or no greater than 12 wt. % or no greater than 10 wt. % or no greater than 9 wt. % or no greater than 8 wt. %. It will be appreciated that the asphalt extender content may be between any of the minimum and maximum values noted above, including for example, but not limited to at least 0.5 wt. % and not greater than 20 wt. % or at least 2 wt. % and not greater than 10 wt. %.

The process for preparing a filled asphalt mix 100 can continue with step 102, oxidizing the asphalt blend to form an oxidized asphalt blend.

The asphalt blend may be subject to an oxidizing (e.g. air blowing) process in order to reach the desired specifications for roofing applications. For example, the asphalt blend may be air blown until it reaches a desired softening point. During this process, air may be blown through the asphalt blend while the asphalt is subject to elevated temperature.

In an embodiment, the oxidized asphalt blend may have a particular oxidized asphalt content that may facilitate improved performance and/or manufacturing of the oxidized asphalt blend or roofing materials prepared therefrom. In an embodiment, the oxidized asphalt blend may comprise at least 70 wt. % an oxidized asphalt for a total weight of the oxidized asphalt blend or at least 71 wt. % or at least 22 wt. % or at least 73 wt. % or at least 74 wt. % or at least 75 wt. % or at least 76 wt. % or at least 77 wt. % or at least 78 wt. % or at least 79 wt. % or at least 80 wt. % or at least 81 wt. % or at least 82 wt. % or at least 83 wt. % or at least 84 wt. % or at least 85 wt. % or at least 86 wt. % or at least 87 wt. % or at least 88 wt. % or at least 89 wt. % or at least 90 wt. %. In another embodiment, the oxidized asphalt blend may comprise no greater than 99.5 wt. % oxidized asphalt for a total weight of the oxidized asphalt blend or no greater than 99 wt. % or no greater than 98 wt. % or no greater than 97 wt. % or no greater than 96 wt. % or no greater than 95 wt. %. It will be appreciated that the oxidized asphalt content may be between any of the minimum and maximum values noted above, including for example, but not limited to at least 70 wt. % and not greater than 99.5 wt. % or at least 80 wt. % and not greater than 95 wt. %.

In an embodiment, the oxidized asphalt blend may have a particular oxidized asphalt extender content that may facilitate improved performance and/or manufacturing of the oxidized asphalt blend or roofing materials prepared therefrom. In an embodiment, the oxidized asphalt blend may comprise at least 0.5 wt. % of an oxidized asphalt extender for a total weight of the oxidized asphalt blend or at least 1 wt. % or at least 2 wt. % or at least 3 wt. % or at least 4 wt. % or at least 5 wt. % or at least 6 wt. %. In another embodiment, the oxidized asphalt blend may comprise no greater than 30 wt. % oxidized asphalt extender for a total weight of the oxidized asphalt blend or no greater than 28 wt. % or no greater than 26 wt. % or no greater than 24 wt. % or no greater than 22 wt. % or no greater than 20 wt. % or no greater than 18 wt. % or no greater than 16 wt. % or no greater than 14 wt. % or no greater than 12 wt. % or no greater than 10 wt. % or no greater than 9 wt. % or no greater than 8 wt. %. It will be appreciated that the oxidized asphalt extender content may be between any of the minimum and maximum values noted above, including for example, but not limited to at least 0.5 wt. % and not greater than 20 wt. % or at least 2 wt. % and not greater than 10 wt. %.

In an embodiment, the oxidized asphalt blend may exhibit a particular softening point that may facilitate improved performance and/or manufacturing of the oxidized asphalt blend or roofing materials prepared therefrom. In an embodiment, the oxidized asphalt blend may exhibit a softening point of at least 194° F. or at least 195° F. or at least 196° F. or at least 197° F. or at least 198° F. or at least 199° F. or at least 200° F. or at least 201° F. or at least 202° F. or at least 203° F. In another embodiment, the oxidized asphalt blend may exhibit a softening point of no greater than no greater than 235° F. or no greater than 230° F. or no greater than 225° F. or no greater than 220° F. or no greater than 212° F. It will be appreciated that the softening point of the oxidized asphalt blend may be between any of the minimum and maximum values noted above, including for example, but not limited to at least 194° F. and not greater than 250° F. or at least 200° F. and not greater than 212° F.

In an embodiment, the oxidized asphalt blend may exhibit a particular penetration at 77° F. that may facilitate improved performance and/or manufacturing of the oxidized asphalt blend or roofing materials prepared therefrom. In an embodiment, the oxidized asphalt blend may exhibit a penetration at 77° F. of at least 12 dmm or at least 12.5 dmm or at least 13 dmm or at least 13.5 dmm or at least 14 dmm or at least 14.5 dmm or at least 15 dmm or at least 15.5 dmm or at least 16 dmm. In another embodiment, the oxidized asphalt blend may exhibit a penetration at 77° F. of no greater than 30 dmm or no greater than 29 dmm or no greater than 28 dmm or no greater than 27 dmm or no greater than 26 dmm or no greater than 25 dmm or no greater than 24 dmm or no greater than 23 dmm or no greater than 22 dmm or no greater than 21 dmm or no greater than 20 dmm or no greater than 19 dmm. It will be appreciated that the penetration at 77° F. of the oxidized asphalt blend may be between any of the minimum and maximum values noted above, including for example, but not limited to at least 12 dmm and not greater than 30 dmm or at least 14 dmm and not greater than 19 dmm.

In an embodiment, the oxidized asphalt blend may exhibit a particular viscosity at 220° C. that may facilitate improved performance and/or manufacturing of the oxidized asphalt blend or roofing materials prepared therefrom. In an embodiment, the oxidized asphalt blend may exhibit a viscosity at 220° C. of at least 150 cP or at least 175 cP or at least 200 cP or at least 225 cP or at least 250 cP. In another embodiment, the oxidized asphalt blend may exhibit a viscosity at 220° C. of no greater than 800 cP or no greater than 750 cP or no greater than 700 cP or no greater than 650 cP or no greater than 600 cP. It will be appreciated that the viscosity at 220° C. of the oxidized asphalt blend may be between any of the minimum and maximum values noted above, including for example, but not limited to at least 250 cP and not greater than 800 cP dmm or at least 175 cP and not greater than 600 cP.

In an embodiment, the oxidized asphalt blend may exhibit a particular viscosity at 200° C. that may facilitate improved performance and/or manufacturing of the oxidized asphalt blend or roofing materials prepared therefrom. In an embodiment, the oxidized asphalt blend may exhibit a viscosity at 200° C. of at least 350 cP or at least 400 cP or at least 450 cP or at least 500 cP or at least 550 cP. In another embodiment, the oxidized asphalt blend may exhibit a viscosity at 200° C. or no greater than 1200 cP or no greater than 1100 cP or no greater than 1000 cP or no greater than 950 cP or no greater than 900 cP. It will be appreciated that the viscosity at 200° C. of the oxidized asphalt blend may be between any of the minimum and maximum values noted above, including for example, but not limited to at least 350 cP and not greater than 1100 cP dmm or at least 500 cP and not greater than 900 cP.

In an embodiment, the oxidized asphalt blend may exhibit a particular viscosity at 180° C. that may facilitate improved performance and/or manufacturing of the oxidized asphalt blend or roofing materials prepared therefrom. In an embodiment, the oxidized asphalt blend may exhibit a viscosity at 180° C. of at least 1000 cP or at least 1100 cP or at least 1200 cP or at least 1300 cP or at least 1400 cP. In another embodiment, the oxidized asphalt blend may exhibit a viscosity at 180° C. of no greater than 2200 cP or no greater than 2100 cP or no greater than 2000 cP or no greater than 1900 cP or no greater than 1800 cP. It will be appreciated that the viscosity at 180° C. of the oxidized asphalt blend may be between any of the minimum and maximum values noted above, including for example, but not limited to at least 1100 cP and not greater than 2200 cP dmm or at least 1300 cP and not greater than 1800 cP.

In an embodiment, the oxidized asphalt blend may exhibit a particular viscosity at 160° C. that may facilitate improved performance and/or manufacturing of the oxidized asphalt blend or roofing materials prepared therefrom. In an embodiment, the oxidized asphalt blend may exhibit a viscosity at 160° C. of at least 2500 cP or at least 2750 cP or at least 3000 cP or at least 3150 cP or at least 3300 cP. In another embodiment, the oxidized asphalt blend may exhibit a viscosity at 160° C. of no greater than 8000 cP or no greater than 7500 cP or no greater than 7000 cP or no greater than 6500 cP or no greater than 6000 cP. It will be appreciated that the viscosity at 160° C. of the oxidized asphalt blend may be between any of the minimum and maximum values noted above, including for example, but not limited to at least 3000 cP and not greater than 7000 cP dmm or at least 3300 cP and not greater than 8000 cP.

In an embodiment, the oxidized asphalt blend may exhibit a particular viscosity at 140° C. that may facilitate improved performance and/or manufacturing of the oxidized asphalt blend or roofing materials prepared therefrom. In an embodiment, the oxidized asphalt blend may exhibit at 140° C. of at least 17000 cP or at least 18000 cP or at least 19000 cP or at least 20000 cP or at least 21000 cP. In another embodiment, the oxidized asphalt blend may exhibit a viscosity at 140° C. of no greater than 30000 cP or no greater than 29000 cP or no greater than 28000 cP or no greater than 27000 cP or no greater than 26000 cP. It will be appreciated that the viscosity at 140° C. of the oxidized asphalt blend may be between any of the minimum and maximum values noted above, including for example, but not limited to at least 17000 cP and not greater than 30000 cP dmm or at least 2000 cP and not greater than 28000 cP.

The process for preparing a filled asphalt mix 100 can continue with step 103, mixing the oxidized asphalt blend with asphalt flux to form a modified oxidized asphalt blend.

In an embodiment, the modified oxidized asphalt blend may have a particular oxidized asphalt content that may facilitate improved performance and/or manufacturing of the modified oxidized asphalt blend or roofing materials prepared therefrom. In an embodiment, the modified oxidized asphalt blend may comprise at least 70 wt. % an oxidized asphalt for a total weight of the modified oxidized asphalt blend or at least 71 wt. % or at least 22 wt. % or at least 73 wt. % or at least 74 wt. % or at least 75 wt. % or at least 76 wt. % or at least 77 wt. % or at least 78 wt. % or at least 79 wt. % or at least 80 wt. % or at least 81 wt. % or at least 82 wt. % or at least 83 wt. % or at least 84 wt. % or at least 85 wt. % or at least 86 wt. % or at least 87 wt. % or at least 88 wt. % or at least 89 wt. % or at least 90 wt. %. In another embodiment, the modified oxidized asphalt blend may comprise no greater than 99 wt. % oxidized asphalt for a total weight of the modified oxidized asphalt blend or no greater than 98 wt. % or no greater than 97 wt. % or no greater than 96 wt. % or no greater than 95 wt. %. It will be appreciated that the oxidized asphalt content may be between any of the minimum and maximum values noted above, including for example, but not limited to at least 70 wt. % and not greater than 99.5 wt. % or at least 80 wt. % and not greater than 95 wt. %.

In an embodiment, the modified oxidized asphalt blend may have a particular oxidized asphalt extender content that may facilitate improved performance and/or manufacturing of the modified oxidized asphalt blend or roofing materials prepared therefrom. In an embodiment, the modified oxidized asphalt blend may comprise at least 0.5 wt. % of an oxidized asphalt extender for a total weight of the modified oxidized asphalt blend or at least 1 wt. % or at least 2 wt. % or at least 3 wt. % or at least 4 wt. % or at least 5 wt. % or at least 6 wt. %. In another embodiment, the modified oxidized asphalt blend may comprise no greater than 20 wt. % oxidized asphalt extender or no greater than 18 wt. % or no greater than 16 wt. % or no greater than 14 wt. % or no greater than 12 wt. % or no greater than 10 wt. % or no greater than 9 wt. % or no greater than 8 wt. %. It will be appreciated that the oxidized asphalt extender content may be between any of the minimum and maximum values noted above, including for example, but not limited to at least 0.5 wt. % and not greater than 20 wt. % or at least 2 wt. % and not greater than 10 wt. %.

In an embodiment, the modified oxidized asphalt blend may have included asphalt flux that may facilitate improved performance and/or manufacturing of the modified oxidized asphalt blend or roofing materials prepared therefrom. The asphalt flux can be a low pen asphalt flux. In an embodiment, the modified oxidized asphalt blend may comprise at least 0.5 wt. % of an asphalt flux for a total weight of the modified oxidized asphalt blend or at least 1 wt. % or at least 2 wt. % or at least 3 wt. % or at least 4 wt. % or at least 5 wt. %. In another embodiment, the modified oxidized asphalt blend may comprise no greater than 15 wt. % asphalt flux or no greater than no greater than 14 wt. % asphalt flux for a total weight of the blend or no greater than 13 wt. % or no greater than 12 wt. % or no greater than 11 wt. % or no greater than 10 wt. % or no greater than 9 wt. % or no greater than 8 wt. %. It will be appreciated that the asphalt flux content may be between any of the minimum and maximum values noted above, including for example, but not limited to at least 0.5 wt. % and not greater than 15 wt. % or at least 2 wt. % and not greater than 10 wt. %.

In an embodiment, then modified oxidized asphalt blend may comprise a particular oxidized asphalt to flux ratio that may facilitate improved performance and/or manufacturing of the modified oxidized asphalt blend or roofing materials prepared therefrom. In an embodiment, the modified oxidized asphalt blend may comprise a ratio of oxidized asphalt to flux of at least 0.1 or at least 0.2 or at least 0.3 or at least 0.4 or at least 0.5 or at least 0.6 or at least 0.7 or at least 0.8 or at least or at least 0.9 or at least 1 or at least 2 or at least 3 or at least 4 or at least 5 or at least 6 or at least 7 or at least 8 or at least 9 or at least 10 or at least 12 or at least 14 or at least 16 or at least 18 or at least 20 or at least 22 or at least 25. In another embodiment, the modified oxidized asphalt blend may exhibit an oxidized asphalt to flux ratio of no greater than 10 or no greater than 9 or no greater than 8 or no greater than 7 or no greater than 6 or no greater than 5 or no greater than 4 or no greater than 3 or no greater than 2 or no greater than 1 or no greater than 0.9 or no greater than 0.8 or no greater than 0.7 or no greater than 0.6 or no greater than 0.5 or no greater than 0.4 or no greater than 0.3 or no greater than 0.2 or no greater than 0.1. It will be appreciated that the oxidized asphalt to flux ratio of the modified oxidized asphalt blend may be between any of the minimum and maximum values noted above, including for example, but not limited to, at least 0.1 and no greater than 25 or at least 0.5 and no greater 10.

In an embodiment, the modified oxidized asphalt blend may exhibit a particular softening point that may facilitate improved performance and/or manufacturing of the modified oxidized asphalt blend or roofing materials prepared therefrom. In an embodiment, the modified oxidized asphalt blend may exhibit a softening point of at least 175° F. or at least 177° F. or at least 179° F. or at least 181° F. or at least 183° F. or at least 185° F. or at least 187° F. or at least 189° F. or at least 191° F. or at least 193° F. or at least 195° F. In another embodiment, the modified oxidized asphalt blend may exhibit a softening point of no greater than 235° F. or no greater than 230° F. or no greater than 220° F. or no greater than 210° F. or no greater than 200° F. It will be appreciated that the softening point of the modified oxidized asphalt blend may be between any of the minimum and maximum values noted above, including for example, but not limited to at least 175° F. and not greater than 235° F. or at least 185° F. and not greater than 210° F.

In an embodiment, the modified oxidized asphalt blend may exhibit a particular penetration at 77° F. that may facilitate improved performance and/or manufacturing of the modified oxidized asphalt blend or roofing materials prepared therefrom. In an embodiment, the modified oxidized asphalt blend may exhibit a penetration at 77° F. of at least 15 dmm or at least 15.5 dmm or at least 16 dmm. In another embodiment, the modified oxidized asphalt blend may exhibit a penetration at 77° F. of no greater than 30 dmm or no greater than 29 dmm or no greater than 28 dmm or no greater than 27 dmm or no greater than 26 dmm or no greater than 25 dmm or no greater than 24 dmm or no greater than 23 dmm or no greater than 22 dmm or no greater than 21 dmm or no greater than 20 dmm or no greater than 19 dmm. It will be appreciated that the penetration at 77° F. of the modified oxidized asphalt blend may be between any of the minimum and maximum values noted above, including for example, but not limited to at least 15 dmm and not greater than 30 dmm or at least 15.5 dmm and not greater than 19 dmm.

In an embodiment, the modified oxidized asphalt blend may exhibit a particular viscosity at 220° C. that may facilitate improved performance and/or manufacturing of the modified oxidized asphalt blend or roofing materials prepared therefrom. In an embodiment, the modified oxidized asphalt blend may exhibit a viscosity at 220° C. of at least 100 cP or at least 125 cP or at least 150 cP or at least 175 cP or at least 200 cP. In another embodiment, the modified oxidized asphalt blend may exhibit a viscosity at 220° C. of no greater than 800 cP or no greater than 750 cP or no greater than 700 cP or no greater than 650 cP or no greater than 600 cP or no greater than 550 cP. It will be appreciated that the viscosity at 220° C. of the modified oxidized asphalt blend may be between any of the minimum and maximum values noted above, including for example, but not limited to at least 150 cP and not greater than 800 cP dmm or at least 175 cP and not greater than 600 cP.

In an embodiment, the modified oxidized asphalt blend may exhibit a particular viscosity at 200° C. that may facilitate improved performance and/or manufacturing of the modified oxidized asphalt blend or roofing materials prepared therefrom. In an embodiment, the modified oxidized asphalt blend may exhibit a viscosity at 200° C. of at least 250 cP or at least 300 cP or at least 350 cP or at least 400 cP or at least 450 cP or at least 500 cP or at least 550 cP. In another embodiment, the modified oxidized asphalt blend may exhibit a viscosity at 200° C. of no greater than 1200 cP or no greater than 1100 cP or no greater than 1000 cP or no greater than 950 cP or no greater than 900 cP or no greater than 850 cP or no greater than 800 cP. It will be appreciated that the viscosity at 200° C. of the modified oxidized asphalt blend may be between any of the minimum and maximum values noted above, including for example, but not limited to at least 350 cP and not greater than 1100 cP dmm or at least 500 cP and not greater than 900 cP.

In an embodiment, the modified oxidized asphalt blend may exhibit a particular viscosity at 180° C. that may facilitate improved performance and/or manufacturing of the modified oxidized asphalt blend or roofing materials prepared therefrom. In an embodiment, the modified oxidized asphalt blend may exhibit a viscosity at 180° C. of at least 500 cP or at least 600 cP or at least 700 cP or at least 800 cP or at least 900 cP. In another embodiment, the modified oxidized asphalt blend may exhibit a viscosity at 180° C. no greater than 2200 cP or no greater than 2100 cP or no greater than 2000 cP or no greater than 1900 cP or no greater than 1800 cP or no greater than 1700 cP or no greater than 1600 cP. It will be appreciated that the viscosity at 180° C. of the modified oxidized asphalt blend may be between any of the minimum and maximum values noted above, including for example, but not limited to at least 500 cP and not greater than 2200 cP dmm or at least 900 cP and not greater than 1800 cP.

In an embodiment, the modified oxidized asphalt blend may exhibit a particular viscosity at 160° C. that may facilitate improved performance and/or manufacturing of the modified oxidized asphalt blend or roofing materials prepared therefrom. In an embodiment, the modified oxidized asphalt blend may exhibit a viscosity at 160° C. of at least 2000 cP or at least 2250 cP or at least 2500 cP or at least 2750 cP or at least 3000 cP. In another embodiment, the modified oxidized asphalt blend may exhibit a viscosity at 160° C. of no greater than 8000 cP or no greater than 7500 cP or no greater than 7000 cP or no greater than 6500 cP or no greater than 6000 cP or no greater than 5500 cP or no greater than 5000 cP. It will be appreciated that the viscosity at 160° C. of the modified oxidized asphalt blend may be between any of the minimum and maximum values noted above, including for example, but not limited to at least 3000 cP and not greater than 7000 cP dmm or at least 2500 cP and not greater than 8000 cP.

In an embodiment, the modified oxidized asphalt blend may exhibit a particular viscosity at 140° C. that may facilitate improved performance and/or manufacturing of the modified oxidized asphalt blend or roofing materials prepared therefrom. In an embodiment, the modified oxidized asphalt blend may exhibit at 140° C. of at least 17000 cP or at least 18000 cP or at least 19000 cP or at least 20000 cP or at least 21000 cP. In another embodiment, the modified oxidized asphalt blend may exhibit a viscosity at 140° C. of no greater than 30000 cP or no greater than 29000 cP or no greater than 28000 cP or no greater than 27000 cP or no greater than 26000 cP. It will be appreciated that the viscosity at 140° C. of the modified oxidized asphalt blend may be between any of the minimum and maximum values noted above, including for example, but not limited to at least 17000 cP and not greater than 30000 cP dmm or at least 2000 cP and not greater than 28000 cP.

In an embodiment, the modified oxidized asphalt blend may exhibit a particular heat absorption factor that may facilitate improved performance and/or manufacturing of the modified oxidized asphalt blend or roofing materials prepared therefrom. Heat absorption factor may be evaluated from asphalt blends according to the process outlined in the examples. It is believed to be beneficial for fire resistance and burning brand tests as the asphalt will absorb heat during the fire. In an embodiment, the modified oxidized asphalt blend can have a Heat absorption factor of at least 8750 J/g or at least 8800 J/g or at least 8850 J/g or at least 8900 J/g or at least 8950 J/g or at least 9000 J/g or at least 9050 J/g or at least 9100 J/g or at least 9150 J/g or at least 9200 J/g or at least 9250 J/g or at least 9300 J/g or at least 9350 J/g or at least 9400 J/g. In an embodiment, the modified oxidized asphalt blend can have a Heat absorption factor of no greater than 20000 J/g no greater than 19500 J/g no greater than 19000 J/g no greater than 18500 J/g no greater than 18000 J/g no greater than 17500 J/g no greater than 17000 J/g no greater than 16500 J/g no greater than 16000 J/g no greater than 15500 J/g no greater than 15000 J/g no greater than 14500 J/g no greater than 14000 J/g no greater than 13500 J/g no greater than 13000 J/g no greater than 12500 J/g no greater than 12000 J/g no greater than 11500 J/g no greater than 11000 J/g no greater than 10500 J/g. It will be appreciated that the Heat absorption factor of the asphalt blend may be between any of the minimum and maximum values noted above, including for example, but not limited to at least 8750 J/g and no greater than 20000 J/g or at least 9000 J/g and no greater than 11000 J/g.

The process for preparing a filled asphalt mix 100 can continue with step 104, mixing the modified oxidized asphalt blend with a filler to form a filled asphalt mix.

In an embodiment, the filler can comprise limestone or calcium carbonate.

In an embodiment, the filled asphalt mix may have a particular filler content that may facilitate improved performance and/or manufacturing of filled asphalt mix or roofing materials prepared therefrom. In an embodiment, the modified oxidized asphalt blend may comprise filler content of at least 40 wt. % filler relative to the weight of the asphalt blend or at least 42 wt. % or at least 44 wt. % or at least 46 wt. % or at least 48 wt. % or at least 50 wt. % or at least 52 wt. % or at least 54 wt. % or at least 56 wt. % or at least 58 wt. % or at least 60 wt. % or at least 61 wt. % or at least 62 wt. % or at least 63 wt. % or at least 64 wt. % or at least 65 wt. % or at least 66 wt. % or at least 67 wt. % or at least 68 wt. % or at least 69 wt. % or at least 70 wt. % or at least 71 wt. % or at least 72 wt. % or at least 73 wt. % or at least 74 wt. % or at least 75 wt. % or at least 76 wt. % or at least 77 wt. % or at least 78 wt. % or at least 79 wt. % or at least 80 wt. %. In another embodiment, the filled asphalt mix may comprise a filler content of not greater than 90 wt. % filler for a total weight of the mix or not greater than 88 wt. % or not greater than 86 wt. % or not greater than 84 wt. % or not greater than 82 wt. % or not greater than 80 wt. % or not greater than 79 wt. % or not greater than 78 wt. % or not greater than 77 wt. % or not greater than 76 wt. % or not greater than 75 wt. % or not greater than 74 wt. % or not greater than 73 wt. % or not greater than 72 wt. % or not greater than 71 wt. % or not greater than 70 wt. % or not greater than 69 wt. % or not greater than 68 wt. % or not greater than 67 wt. % or not greater than 66 wt. % or not greater than 65 wt. % or not greater than 64 wt. % or not greater than 63 wt. % or not greater than 2 wt. % or not greater than 61 wt. % or not greater than 60 wt. %. It will be appreciated that the filler content may be between any of the minimum and maximum values noted above, including for example, but not limited to at least 60 wt. % and not greater than 80 wt. % or at least 60 wt. % and not greater than 70 wt. %.

In an embodiment, the filled asphalt mix may exhibit a softening point that may facilitate improved performance and/or manufacturing of the filled asphalt mix or roofing materials prepared therefrom. In an embodiment, the filled asphalt mix may exhibit a softening point of at least 194° F. or at least 196° F. or at least 198° F. or at least 200° F. or at least 202° F. or at least 204° F. or at least 206° F. or at least 208° F. or at least 210° F. or at least 212° F. In another embodiment, the filled asphalt mix may exhibit a softening point of no greater than 265° F. or no greater than 260° F. or no greater than 255° F. or no greater than 250° F. or no greater than 245° F. or no greater than 240° F. or no greater than 235° F. or no greater than 230° F. It will be appreciated that the softening point of the filled asphalt mix may be between any of the minimum and maximum values noted above, including for example, but not limited to at least 194° F. and not greater than 260° F. or at least 200° F. and not greater than 240° F.

In an embodiment, the filled asphalt mix may exhibit a particular penetration at 77° F. that may facilitate improved performance and/or manufacturing of the filled asphalt mix or roofing materials prepared therefrom. In an embodiment, the filled asphalt mix may exhibit a penetration at 77° F. of at least 4 dmm or at least 4.5 dmm or at least 5 dmm or at least 5.5 dmm or at least 6 dmm or at least 6.5 dmm or at least 7 dmm or at least 7.5 dmm or at least 8 dmm or at least 8.5 dmm or at least 9 dmm or at least 9.5 dmm or at least 10 dmm or at least 10.5 dmm or at least 11 dmm. In another embodiment, the filled asphalt mix may exhibit a penetration at 77° F. of no greater than 20 dmm or no greater than 19 dmm or no greater than 18 dmm or no greater than 17 dmm or no greater than 16 dmm or no greater than 15 dmm or no greater than 14 dmm or no greater than 13 dmm or no greater than 12 dmm or no greater than 11 dmm or no greater than 10 dmm. It will be appreciated that the penetration at 77° F. of the filled asphalt mix may be between any of the minimum and maximum values noted above, including for example, but not limited to at least 4 dmm and not greater than 19 dmm or at least 8 dmm and not greater than 13 dmm.

According to another aspect, an asphalt blend may include an overoxidized asphalt and an asphalt flux.

In an embodiment, the overoxidized asphalt may be prepared by oxidizing or air blowing asphalt flux. The overoxidized asphalt may be blown until it has a particular softening point that may facilitate improved performance and/or manufacturing of the asphalt blend or roofing articles prepared therefrom. In an embodiment, the overoxidized asphalt may exhibit a softening point of at least 235° F. or at least 240° F. or at least 245° F. In another embodiment, the overoxidized asphalt may exhibit a softening point of not greater than 300° F. or not greater than 290° F. or not greater than 280° F. or not greater than 270° F. or not greater than 260° F. or not greater than 255° F. It will be appreciated that the softening point of the overoxidized asphalt may be between any of the minimum and maximum values noted above. Including for example, but not limited to at least 235° F. and not greater than 300° F. or at least 240° F. and not greater than 280° F.

The overoxidized asphalt exhibit a particular penetration at 77° F. that may facilitate improved performance and/or manufacturing of the asphalt blend or roofing articles prepared therefrom. In an embodiment, the overoxidized asphalt may exhibit a penetration at 77° F. of at least 10 dmm or at least 11 dmm or at least 12 dmm or at least 13 dmm or at least 14 dmm or at least 15 dmm or at least 16 dmm. In another embodiment, the overoxidized asphalt may exhibit a penetration at 77° F. of no greater than 30 dmm or no greater than 28 dmm or no greater than 26 dmm or no greater than 24 dmm or no greater than 22 dmm or no greater than 20 dmm. It will be appreciated that the softening point of the overoxidized asphalt may be between any of the minimum and maximum values noted above. Including for example, but not limited to, at least 10 dmm and not greater than 30 dmm or at least 16 dmm and not greater than 20 dmm.

In an embodiment, the overoxidized asphalt may be mixed with an asphalt flux. The asphalt flux may be from the same asphalt flux that was used to prepare the overoxidized asphalt. The asphalt flux may be a different asphalt flux than the flux used to prepare an overoxidized asphalt. The asphalt flux may have a particular penetration at 77° F. that may facilitate improved performance and/or manufacturing of the asphalt blend or roofing materials prepared therefrom. In an embodiment, the asphalt flux may have any penetration in the range at 77° F. of 140-400 dmm.

In an embodiment, the asphalt blend may contain a particular overoxidized asphalt content that may facilitate improved performance and/or manufacturing of the asphalt blend or roofing materials prepared therefrom. In an embodiment the asphalt blend may comprise at least 10 wt. % overoxidized asphalt or at least 20 wt. % or at least 30 wt. % or at least 40 wt. % or at least 50 wt. % or at least 55 wt. % or at least 60 wt. % or at least 65 wt. % or at least 70 wt. % or at least 75 wt. % or at least 80 wt. % or at least 85 wt. % or at least 95 wt. %. In another embodiment, the asphalt blend may comprise no greater than no greater than 99 wt. % overoxidized asphalt or no greater than 98 wt. % or no greater than 97 wt. % or no greater than 96 wt. % or no greater than 95 wt. % or no greater than 94 wt. % or no greater than 93 wt. % or no greater than 92 wt. % or no greater than 91 wt. % or no greater than 90 wt. % or no greater than 80 wt. % or no greater than 70 wt. % or no greater than 60 wt. % or no greater than 50 wt. % or no greater than 40 wt. % or no greater than 30 wt. % or no greater than 20 wt. % or no greater than 10 wt. % overoxidized asphalt. It will be appreciated that the overoxidized asphalt content may be between any of the minimum and maximum values noted above, including for example, but not limited to at least 50 wt. % and no greater than 95 wt. % overoxidized asphalt or at least 80 wt. % and no greater than 95 wt. % overoxidized asphalt.

In an embodiment, the asphalt blend may contain a particular asphalt flux content that may facilitate improved performance and/or manufacturing of the asphalt blend or roofing materials prepared therefrom. In an embodiment the asphalt blend may comprise at least at least 1 wt. % asphalt flux or at least 2 wt. % or at least 3 wt. % or at least 4 wt. % or at least 5 wt. % or at least 6 wt. % or at least 7 wt. % or at least 8 wt. % or at least 9 wt. % or at least 10 wt. % or at least 20 wt. % or at least 30 wt. % or at least 40 wt. % or at least 50 wt. % or at least 55 wt. % or at least 60 wt. % or at least 65 wt. % or at least 70 wt. % or at least 75 wt. % or at least 80 wt. % or at least 85 wt. % or at least 95 wt. %. In another embodiment, the asphalt blend may comprise no greater than no greater than 99 wt. % asphalt flux or no greater than 98 wt. % or no greater than 97 wt. % or no greater than 96 wt. % or no greater than 95 wt. % or no greater than 94 wt. % or no greater than 93 wt. % or no greater than 92 wt. % or no greater than 91 wt. % or no greater than 90 wt. % or no greater than 80 wt. % or no greater than 70 wt. % or no greater than 60 wt. % or no greater than 50 wt. % no greater than 45 wt. % or no greater than 40 wt. % or no greater than 35 wt. % or no greater than 30 wt. % or no greater than 25 wt. % or no greater than 20 wt. % or no greater than 15 wt. % or no greater than 10 wt. % asphalt flux. It will be appreciated that the asphalt flux content may be between any of the minimum and maximum values noted above, including for example, but not limited to at least 1 wt. % and no greater than 20 wt. % asphalt flux or at least 5 wt. % and no greater than 15 wt. % asphalt flux.

In an embodiment, the asphalt blend may comprise a particular overoxidized asphalt to flux ratio that may facilitate improved performance and/or manufacturing of the asphalt blend or roofing materials prepared therefrom. In an embodiment, the asphalt blend may comprise a ratio of overoxidized asphalt to flux of at least 0.1 or at least 0.2 or at least 0.3 or at least 0.4 or at least 0.5 or at least 0.6 or at least 0.7 or at least 0.8 or at least or at least 0.9 or at least 1 or at least 2 or at least 3 or at least 4 or at least 5 or at least 6 or at least 7 or at least 8 or at least 9 or at least 10 or at least 12 or at least 14 or at least 16 or at least 18 or at least 20 or at least 22 or at least 25. In another embodiment, the asphalt blend may exhibit an overoxidized asphalt to flux ratio of no greater than 10 or no greater than 9 or no greater than 8 or no greater than 7 or no greater than 6 or no greater than 5 or no greater than 4 or no greater than 3 or no greater than 2 or no greater than 1 or no greater than 0.9 or no greater than 0.8 or no greater than 0.7 or no greater than 0.6 or no greater than 0.5 or no greater than 0.4 or no greater than 0.3 or no greater than 0.2 or no greater than 0.1. It will be appreciated that the overoxidized asphalt to flux ratio of the asphalt blend may be between any of the minimum and maximum values noted above, including for example, but not limited to, at least 0.1 and no greater than 25 or at least 0.5 and no greater 10.

In an embodiment, the asphalt blend may have a penetration at 77° F. that may facilitate improved performance and/or manufacturing of the asphalt blend or roofing materials prepared therefrom. In an embodiment the asphalt blend may exhibit a penetration at 77° F. of at least 15 dmm or at least 16 dmm or at least 17 dmm or at least 18 dmm or at least 19 dmm. In an embodiment, the asphalt blend may exhibit a penetration at 77° F. of no greater than 30 dmm or no greater than 28 dmm or no greater than 26 dmm or no greater than 24 dmm or no greater than 22 dmm. It will be appreciated that the asphalt blend may exhibit a penetration at 77° F. between any of the minimum and maximum values noted above, including for example but not limited to at least 15 dmm and not greater than 30 dmm or at least 16 dmm and no greater than 22 dmm.

In an embodiment, the asphalt blend may have a softening point that may facilitate improved performance and/or manufacturing of the asphalt blend or roofing materials prepared therefrom. In an embodiment the asphalt blend may exhibit a softening point of no greater than 235° F. or no greater than 230° F. or no greater than 225° F. In an embodiment, the asphalt blend may exhibit a softening point of at least 190° F. or at least 195° F. or at least 200° F. or at least 205 OF or at least 210° F. or at least 215° F. or at least 220° F. It will be appreciated that the asphalt blend may exhibit a softening point between any of the minimum and maximum values noted above, including for example but not limited to at least 190° F. and not greater than 235° F. or at least 220° F. and not greater than 225° F.

In an embodiment, the asphalt blend may have a particular viscosity at 200° C. that may facilitate improved performance and/or manufacturing of the asphalt blend or roofing materials prepared therefrom. In an embodiment the asphalt blend may exhibit a viscosity at 200° C. of at least 250 cP or at least 300 cP or at least 350 cP or at least 400 cP or at least 450 cP or at least 500 cP or at least 550 cP. In an embodiment, the asphalt blend may exhibit a viscosity at 200° C. of no greater than 1200 cP or no greater than 1100 cP or no greater than 1000 cP or no greater than 950 cP or no greater than 900 cP or no greater than 850 cP or no greater than 800 cP. It will be appreciated that the asphalt blend may exhibit a viscosity at 200° C. between any of the minimum and maximum values noted above, including for example but not limited to at least 250 cP and not greater than 1200 cP or at least 300 cP and not greater than 900 cP.

In an embodiment, the asphalt blend may exhibit a particular heat absorption factor that may facilitate improved performance and/or manufacturing of the modified oxidized asphalt blend or roofing materials prepared therefrom. Heat absorption factor may be evaluated from asphalt blends according to the process outlined in the examples. It is believed to be beneficial for fire resistance and burning brand tests as the asphalt will absorb heat during the fire. In an embodiment, the asphalt blend can have a Heat absorption factor of at least 8750 J/g or at least 8800 J/g or at least 8850 J/g or at least 8900 J/g or at least 8950 J/g or at least 9000 J/g or at least 9050 J/g or at least 9100 J/g or at least 9150 J/g or at least 9200 J/g or at least 9250 J/g or at least 9300 J/g or at least 9350 J/g or at least 9400 J/g or at least 9500 J/g or at least 10000 J/g or at least 10500 J/g or at least 11000 J/g. In an embodiment, the asphalt blend can have a Heat absorption factor of no greater than 20000 J/g no greater than 19500 J/g no greater than 19000 J/g no greater than 18500 J/g no greater than 18000 J/g no greater than 17500 J/g no greater than 17000 J/g no greater than 16500 J/g no greater than 16000 J/g no greater than 15500 J/g no greater than 15000 J/g no greater than 14500 J/g no greater than 14000 J/g. It will be appreciated that the Heat absorption factor of the asphalt blend may be between any of the minimum and maximum values noted above, including for example, but not limited to at least 8750 J/g and no greater than 20000 J/g or at least 9000 J/g and no greater than 15000 J/g.

The asphalt blend may be mixed with a filler to form a filled asphalt mix.

In an embodiment, the filler can comprise limestone or calcium carbonate.

In an embodiment, the filled asphalt mix may have a particular filler content that may facilitate improved performance and/or manufacturing of filled asphalt mix or roofing materials prepared therefrom. In an embodiment, the modified oxidized asphalt blend may comprise filler content of at least 40 wt. % filler relative to the weight of the asphalt blend or at least 42 wt. % or at least 44 wt. % or at least 46 wt. % or at least 48 wt. % or at least 50 wt. % or at least 52 wt. % or at least 54 wt. % or at least 56 wt. % or at least 58 wt. % or at least 60 wt. % or at least 61 wt. % or at least 62 wt. % or at least 63 wt. % or at least 64 wt. % or at least 65 wt. % or at least 66 wt. % or at least 67 wt. % or at least 68 wt. % or at least 69 wt. % or at least 70 wt. % or at least 71 wt. % or at least 72 wt. % or at least 73 wt. % or at least 74 wt. % or at least 75 wt. % or at least 76 wt. % or at least 77 wt. % or at least 78 wt. % or at least 79 wt. % or at least 80 wt. %. In another embodiment, the filled asphalt mix may comprise a filler content of not greater than 90 wt. % filler for a total weight of the mix or not greater than 88 wt. % or not greater than 86 wt. % or not greater than 84 wt. % or not greater than 82 wt. % or not greater than 80 wt. % or not greater than 79 wt. % or not greater than 78 wt. % or not greater than 77 wt. % or not greater than 76 wt. % or not greater than 75 wt. % or not greater than 74 wt. % or not greater than 73 wt. % or not greater than 72 wt. % or not greater than 71 wt. % or not greater than 70 wt. % or not greater than 69 wt. % or not greater than 68 wt. % or not greater than 67 wt. % or not greater than 66 wt. % or not greater than 65 wt. % or not greater than 64 wt. % or not greater than 63 wt. % or not greater than 2 wt. % or not greater than 61 wt. % or not greater than 60 wt. %. It will be appreciated that the filler content may be between any of the minimum and maximum values noted above, including for example, but not limited to at least 60 wt. % and not greater than 80 wt. % or at least 60 wt. % and not greater than 70 wt. %.

### EMBODIMENTS

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### Embodiment 1

An asphalt blend comprising:
70-99.5 wt. % asphalt flux and 0.5-30 wt. % of an asphalt extender.

### Embodiment 2

The asphalt blend of embodiment 1, wherein the asphalt blend comprises at least 71 wt. % asphalt flux for a total weight of the blend or at least 72 wt. % or at least 73 wt. % or at least 74 wt. % or at least 75 wt. % or at least 76 wt. % or at least 77 wt. % or at least 78 wt. % or at least 79 wt. % or at least 80 wt. % or at least 81 wt. % or at least 82 wt. % or at least 83 wt. % or at least 84 wt. % or at least 85 wt. % or at least 86 wt. % or at least 87 wt. % or at least 88 wt. % or at least 89 wt. % or at least 90 wt. %

### Embodiment 3

The asphalt blend of embodiment 1 or embodiment 2, wherein the asphalt blend further comprises no greater than 99 wt. % asphalt flux for a total weight of the blend or no greater than 98 wt. % or no greater than 97 wt. % or no greater than 96 wt. % or no greater than 95 wt. %.

### Embodiment 4

The asphalt blend of any of embodiments 1 to 3, wherein the asphalt extender comprises wax, vacuum tower asphalt extender, re-refined engine oil bottoms, bio-oil, process oil, or combinations thereof.

### Embodiment 5

The asphalt blend of any of embodiments 1 to 4, wherein the asphalt extender comprises tower asphalt extender or re-refined engine oil bottoms.

### Embodiment 6

The asphalt blend of any of embodiments 1 to 5, wherein the asphalt blend comprises at least 1 wt. % of an asphalt extender for a total weight of the blend or at least 2 wt. % or at least 3 wt. % or at least 4 wt. % or at least 5 wt. % or at least 6 wt. %.

### Embodiment 7

The asphalt blend of any of embodiments 1 to 6, wherein the asphalt blend further comprises no greater than 28 wt. % asphalt extender for a total weight of the blend or no greater than 26 wt. % or no greater than 24 wt. % or no greater than 22 wt. % or no greater than 20 wt. % or no greater than 18 wt. % or no greater than 16 wt. % or no greater than 14 wt. % or no greater than 12 wt. % or no greater than 10 wt. % or no greater than 9 wt. % or no greater than 8 wt. %

### Embodiment 8

An oxidized asphalt blend comprising:
70-99.5 wt. % an oxidized asphalt and 0.5-20 wt. % of oxidized asphalt extender.

### Embodiment 9

The oxidized asphalt blend of embodiment 8, wherein the oxidized asphalt blend comprises at least 71 wt. % oxidized asphalt for a total weight of the blend or at least 72 wt. % or at least 73 wt. % or at least 74 wt. % or at least 75 wt. % or at least 76 wt. % or at least 77 wt. % or at least 78 wt. % or at least 79 wt. % or at least 80 wt. % or at least 81 wt. % or at least 82 wt. % or at least 83 wt. % or at least 84 wt. % or at least 85 wt. % or at least 86 wt. % or at least 87 wt. % or at least 88 wt. % or at least 89 wt. % or at least 90 wt. %.

### Embodiment 10

The oxidized asphalt blend of embodiment 8 or 9, wherein the oxidized asphalt blend further comprises no greater than 99 wt. % oxidized asphalt for a total weight of the blend or no greater than 98 wt. % or no greater than or no greater than 97 wt. % or no greater than 96 wt. % or no greater than 95 wt. %.

### Embodiment 11

The oxidized asphalt blend of any one of embodiments 8 to 10, wherein the oxidized asphalt blend comprises at least 1 wt. % of an oxidized asphalt extender for a total weight of the blend or at least 2 wt. % or at least 3 wt. % or at least 4 wt. % or at least 5 wt. % or at least 6 wt. %.

### Embodiment 12

The oxidized asphalt blend of any one of embodiments 8 to 11, wherein the oxidized asphalt blend further comprises no greater than 28 wt. % oxidized asphalt extender for a total weight of the blend or no greater than 26 wt. % or no greater than or no greater than 24 wt. % or no greater than 22 wt. % or no greater than 20 wt. % or no greater than 18 wt. % or no greater than 16 wt. % or no greater than 14 wt. % or no greater than 12 wt. % or no greater than 10 wt. % or no greater than 9 wt. % or no greater than 8 wt. %.

### Embodiment 13

The oxidized asphalt blend of any one of embodiments 8 to 12, wherein the oxidized asphalt blend exhibits a softening point of at least 194° F. or at least 195° F. or at least 196° F. or at least 197° F. or at least 198° F. or at least 199° F. or at least 200° F. or at least 201° F. or at least 202° F. or at least 203° F.

### Embodiment 14

The oxidized asphalt blend of any one of embodiments 8 to 13, wherein the oxidized asphalt blend exhibits a softening point of no greater than 235° F. or no greater than 230° F. or no greater than 225° F. or no greater than 220° F. or no greater than 212° F.

### Embodiment 15

The oxidized asphalt blend of any one of embodiments 8 to 14, wherein the oxidized asphalt blend exhibits a penetration at 77° F. of at least 12 dmm or at least 12.5 dmm or at least 13 dmm or at least 13.5 dmm or at least 14 dmm or at least 14.5 dmm or at least 15 dmm or at least 15.5 dmm or at least 16 dmm.

### Embodiment 16

The oxidized asphalt blend of any one of embodiments 8 to 15, wherein the oxidized asphalt blend exhibits a penetration at 77° F. of no greater than 30 dmm or no greater than 29 dmm or no greater than 28 dmm or no greater than 27 dmm or no greater than 26 dmm or no greater than 25 dmm or no greater than 24 dmm or no greater than 23 dmm or no greater than 22 dmm or no greater than 21 dmm or no greater than 20 dmm or no greater than 19 dmm.

### Embodiment 17

The oxidized asphalt blend of any one of embodiments 8 to 16, wherein the oxidized asphalt blend exhibits a viscosity at 220° C. of at least 150 cP or at least 175 cP or at least 200 cP or at least 225 cP or at least 250 cP.

### Embodiment 18

The oxidized asphalt blend of any one of embodiments 8 to 17, wherein the oxidized asphalt blend exhibits a viscosity at 220° C. of no greater than 800 cP or no greater than 750 cP or no greater than 700 cP or no greater than 650 cP or no greater than 600 cP.

### Embodiment 19

The oxidized asphalt blend of any one of embodiments 8 to 18, wherein the oxidized asphalt blend exhibits a viscosity at 200° C. of at least 350 cP or at least 400 cP or at least 450 cP or at least 500 cP or at least 550 cP.

### Embodiment 20

The oxidized asphalt blend of any one of embodiments 8 to 19, wherein the oxidized asphalt blend exhibits a viscosity at 200° C. of no greater than 1200 cP or no greater than 1100 cP or no greater than 1000 cP or no greater than 950 cP or no greater than 900 cP.

### Embodiment 21

The oxidized asphalt blend of any one of embodiments 8 to 20, wherein the oxidized asphalt blend exhibits a viscosity at 180° C. of at least 1000 cP or at least 1100 cP or at least 1200 cP or at least 1300 cP or at least 1400 cP.

### Embodiment 22

The oxidized asphalt blend of any one of embodiments 8 to 21, wherein the oxidized asphalt blend exhibits a viscosity at 180° C. of no greater than 2200 cP or no greater than 2100 cP or no greater than 2000 cP or no greater than 1900 cP or no greater than 1800 cP.

### Embodiment 23

The oxidized asphalt blend of any one of embodiments 8 to 21, wherein the oxidized asphalt blend exhibits a viscosity at 160° C. of at least 2500 cP or at least 2750 cP or at least 3000 cP or at least 3150 cP or at least 3300 cP.

### Embodiment 24

The oxidized asphalt blend of any one of embodiments 8 to 22, wherein the oxidized asphalt blend exhibits a viscosity at 160° C. of no greater than 8000 cP or no greater than 7500 cP or no greater than 7000 cP or no greater than 6500 cP or no greater than 6000 cP.

### Embodiment 25

The oxidized asphalt blend of any one of embodiments 8 to 23, wherein the oxidized asphalt blend exhibits a viscosity at 140° C. of at least 17000 cP or at least 18000 cP or at least 19000 cP or at least 20000 cP or at least 21000 cP.

### Embodiment 26

The oxidized asphalt blend of any one of embodiments 8 to 25, wherein the oxidized asphalt blend exhibits a viscosity at 140° C. of no greater than 30000 cP or no greater than 29000 cP or no greater than 28000 cP or no greater than 27000 cP or no greater than 26000 cP.

### Embodiment 27

A modified oxidized asphalt blend comprising:
70-99.5 wt. % an oxidized asphalt;
0.5-20 wt. % of an oxidized asphalt extender; and 0.5-15 wt. % asphalt flux.

### Embodiment 28

The modified oxidized asphalt blend of embodiment 27, wherein the modified oxidized asphalt blend comprises at least 71 wt. % oxidized asphalt for a total weight of the blend or at least 72 wt. % or at least 73 wt. % or at least 74 wt. % or at least 75 wt. % or at least 76 wt. % or at least 77 wt. % or at least 78 wt. % or at least 79 wt. % or at least 80 wt. % or at least 81 wt. % or at least 82 wt. % or at least 83 wt. % or at least 84 wt. % or at least 85 wt. % or at least 86 wt. % or at least 87 wt. % or at least 88 wt. % or at least 89 wt. % or at least 90 wt. %.

### Embodiment 29

The modified oxidized asphalt blend of embodiment 27 or embodiment 28, wherein the modified oxidized asphalt blend further comprises no greater than 99 wt. % oxidized asphalt for a total weight of the blend or no greater than 98 wt. % or no greater than or no greater than 97 wt. % or no greater than 96 wt. % or no greater than 95 wt. %.

### Embodiment 30

The modified oxidized asphalt blend of any one of embodiments 27 to 29, wherein the modified oxidized asphalt blend comprises at least 1 wt. % of an oxidized asphalt extender for a total weight of the blend or at least 2 wt. % or at least 3 wt. % or at least 4 wt. % or at least 5 wt. % or at least 6 wt. %.

### Embodiment 31

The modified oxidized asphalt blend of any one of embodiments 27 to 30, wherein the modified oxidized asphalt blend further comprises no greater than 20 wt. % oxidized asphalt extender or no greater than 18 wt. % or no greater than 16 wt. % or no greater than 14 wt. % or no greater than 12 wt. % or no greater than 10 wt. % or no greater than 9 wt. % or no greater than 8 wt. %.

### Embodiment 32

The modified oxidized asphalt blend of any one of embodiments 27 to 31, wherein the modified oxidized asphalt blend comprises at least 1 wt. % of asphalt flux for a total weight of the blend or at least 2 wt. % or at least 3 wt. % or at least 4 wt. % or at least 5 wt. %.

### Embodiment 33

The modified oxidized asphalt blend of any one of embodiments 27 to 32, wherein the modified oxidized asphalt blend further comprises no greater than 14 wt. % asphalt flux for a total weight of the blend or no greater than 13 wt. % or no greater than 12 wt. % or no greater than 11 wt. % or no greater than 10 wt. % or no greater than 9 wt. % or no greater than 8 wt. %.

### Embodiment 34

The modified oxidized asphalt blend of any one of embodiments 27 to 33, wherein the modified oxidized asphalt blend comprises a ratio of oxidized asphalt to asphalt flux of at least 0.1 or at least 0.2 or at least 0.3 or at least 0.4 or at least 0.5 or at least 0.6 or at least 0.7 or at least 0.8 or at least or at least 0.9 or at least 1 or at least 2 or at least 3 or at least 4 or at least 5 or at least 6 or at least 7 or at least 8 or at least 9 or at least 10 or at least 12 or at least 14 or at least 16 or at least 18 or at least 20 or at least 22 or at least 25.

### Embodiment 35

The modified oxidized asphalt blend of any one of embodiments 27 to 34, wherein the modified oxidized asphalt blend comprises a ratio of oxidized asphalt to asphalt flux of no greater than 10 or no greater than 9 or no greater than 8 or no greater than 7 or no greater than 6 or no greater than 5 or no greater than 4 or no greater than 3 or no greater than 2 or no greater than 1 or no greater than 0.9 or no greater than 0.8 or no greater than 0.7 or no greater than 0.6 or no greater than 0.5 or no greater than 0.4 or no greater than 0.3 or no greater than 0.2 or no greater than 0.1.

### Embodiment 36

The modified oxidized asphalt blend of any one of embodiments 27 to 35, wherein the modified oxidized asphalt blend exhibits a softening point of at least at least 175 OF or at least 177° F. or at least 179° F. or at least 181° F. or at least 183° F. or at least 185° F. or at least 187° F. or at least 189° F. or at least 191° F. or at least 193° F. or at least 195° F.

### Embodiment 37

The modified oxidized asphalt blend of any one of embodiments 27 to 36, wherein the modified oxidized asphalt blend exhibits a softening point of no greater than 235 OF or no greater than 230° F. or no greater than 220° F. or no greater than 210° F. or no greater than 200° F.

### Embodiment 38

The modified oxidized asphalt blend of any one of embodiments 27 to 37, wherein the modified oxidized asphalt blend exhibits a penetration at 77° F. of at least 15 dmm or at least 15.5 dmm or at least 16 dmm.

### Embodiment 39

The modified oxidized asphalt blend of any one of embodiments 27 to 38, wherein the modified oxidized asphalt blend exhibits a penetration at 77° F. of no greater than 30 dmm or no greater than 29 dmm or no greater than 28 dmm or no greater than 27 dmm or no greater than 26 dmm or no greater than 25 dmm or no greater than 24 dmm or no greater than 23 dmm or no greater than 22 dmm or no greater than 21 dmm or no greater than 20 dmm or no greater than 19 dmm.

### Embodiment 40

The modified oxidized asphalt blend of any one of embodiments 27 to 39, wherein the modified oxidized asphalt blend exhibits a Heat absorption factor of at least 8750 J/g or at least 8800 J/g or at least 8850 J/g or at least 8900 J/g or at least 8950 J/g or at least 9000 J/g or at least 9050 J/g or at least 9100 J/g or at least 9150 J/g or at least 9200 J/g or at least 9250 J/g or at least 9300 J/g or at least 9350 J/g or at least 9400 J/g.

### Embodiment 41

The modified oxidized asphalt blend of any one of embodiments 27 to 39, wherein the modified oxidized asphalt blend exhibits a Heat absorption factor of no greater than 20000 J/g no greater than 19500 J/g no greater than 19000 J/g no greater than 18500 J/g no greater than 18000 J/g no greater than 17500 J/g no greater than 17000 J/g no greater than 16500 J/g no greater than 16000 J/g no greater than 15500 J/g no greater than 15000 J/g no greater than 14500 J/g no greater than 14000 J/g no greater than 13500 J/g no greater than 13000 J/g no greater than 12500 J/g no greater than 12000 J/g no greater than 11500 J/g no greater than 11000 J/g no greater than 10500 J/g.

### Embodiment 42

The modified oxidized asphalt blend of any one of embodiments 27 to 41, wherein the oxidized asphalt blend exhibits a viscosity at 220° C. of at least 100 cP or at least 125 cP or at least 150 cP or at least 175 cP or at least 200 cP.

### Embodiment 43

The modified oxidized asphalt blend of any one of embodiments 27 to 42, wherein the modified oxidized asphalt blend exhibits a viscosity at 220° C. of no greater than 800 cP or no greater than 750 cP or no greater than 700 cP or no greater than 650 cP or no greater than 600 cP or no greater than 550 cP.

### Embodiment 44

The modified oxidized asphalt blend of any one of embodiments 27 to 43, wherein the modified oxidized asphalt blend exhibits a viscosity at 200° C. of at least 250 cP or at least 300 cP or at least 350 cP or at least 400 cP or at least 450 cP or at least 500 cP or at least 550 cP.

### Embodiment 45

The modified oxidized asphalt blend of any one of embodiments 27 to 44, wherein the modified oxidized asphalt blend exhibits a viscosity at 200° C. of no greater than 1200 cP or no greater than 1100 cP or no greater than 1000 cP or no greater than 950 cP or no greater than 900 cP or no greater than 850 cP or no greater than 800 cP.

### Embodiment 46

The modified oxidized asphalt blend of any one of embodiments 27 to 45, wherein the modified oxidized asphalt blend exhibits a viscosity at 180° C. of at least 500 cP or at least 600 cP or at least 700 cP or at least 800 cP or at least 900 cP.

### Embodiment 47

The modified oxidized asphalt blend of any one of embodiments 27 to 46, wherein the modified oxidized asphalt blend exhibits a viscosity at 180° C. of no greater than 2200 cP or no greater than 2100 cP or no greater than 2000 cP or no greater than 1900 cP or no greater than 1800 cP or no greater than 1700 cP or no greater than 1600 cP.

### Embodiment 48

The modified oxidized asphalt blend of any one of embodiments 27 to 47, wherein the modified oxidized asphalt blend exhibits a viscosity at 160° C. of at least 2000 cP or at least 2250 cP or at least 2500 cP or at least 2750 cP or at least 3000 cP.

### Embodiment 49

The modified oxidized asphalt blend of any one of embodiments 27 to 48, wherein the modified oxidized asphalt blend exhibits a viscosity at 160° C. of no greater than 8000 cP or no greater than 7500 cP or no greater than 7000 cP or no greater than 6500 cP or no greater than 6000 cP or no greater than 5500 cP or no greater than 5000 cP.

### Embodiment 50

The modified oxidized asphalt blend of any one of embodiments 27 to 49, wherein the modified oxidized asphalt blend exhibits a viscosity at 140° C. of at least 17000 cP or at least 18000 cP or at least 19000 cP or at least 20000 cP or at least 21000 cP.

### Embodiment 51

The modified oxidized asphalt blend of any one of embodiments 27 to 50, wherein the modified oxidized asphalt blend exhibits a viscosity at 140° C. of no greater than 30000 cP or no greater than 29000 cP or no greater than 28000 cP or no greater than 27000 cP or no greater than 26000 cP.

### Embodiment 52

A filled asphalt mix comprising the asphalt blend of any one of embodiments 1-51, further comprising a filler.

### Embodiment 53

The filled asphalt mix of embodiment 52, wherein the filler comprises limestone.

### Embodiment 54

The filled asphalt mix of embodiment 52 or embodiment 53, wherein the composition comprises a filler content of at least 40 wt. % filler relative to the weight of the asphalt blend or at least 42 wt. % or at least 44 wt. % or at least 46 wt. % or at least 48 wt. % or at least 50 wt. % or at least 52 wt. % or at least 54 wt. % or at least 56 wt. % or at least 58 wt. % or at least 60 wt. % or at least 61 wt. % or at least 62 wt. % or at least 63 wt. % or at least 64 wt. % or at least 65 wt. % or at least 66 wt. % or at least 67 wt. % or at least 68 wt. % or at least 69 wt. % or at least 70 wt. % or at least 71 wt. % or at least 72 wt. % or at least 73 wt. % or at least 74 wt. % or at least 75 wt. % or at least 76 wt. % or at least 77 wt. % or at least 78 wt. % or at least 79 wt. % or at least 80 wt. %.

### Embodiment 55

The filled asphalt mix of any one of embodiments 52 to 54, wherein the composition comprises a filler content of not greater than 90 wt. % filler for a total weight of the mix or not greater than 88 wt. % or not greater than 86 wt. % or not greater than 84 wt. % or not greater than 82 wt. % or not greater than 80 wt. % or not greater than 79 wt. % or not greater than 78 wt. % or not greater than 77 wt. % or not greater than 76 wt. % or not greater than 75 wt. % or not greater than 74 wt. % or not greater than 73 wt. % or not greater than 72 wt. % or not greater than 71 wt. % or not greater than 70 wt. % or not greater than 69 wt. % or not greater than 68 wt. % or not greater than 67 wt. % or not greater than 66 wt. % or not greater than 65 wt. % or not greater than 64 wt. % or not greater than 63 wt. % or not greater than 2 wt. % or not greater than 61 wt. % or not greater than 60 wt. %.

### Embodiment 56

The filled asphalt mix of any one of embodiments 52 to 55, wherein the asphalt mix exhibits a softening point of at least 194° F. or at least 196° F. or at least 198° F. or at least 200° F. or at least 202° F. or at least 204° F. or at least 206° F. or at least 208° F. or at least 210° F. or at least 212° F.

### Embodiment 57

The filled asphalt mix of any one of embodiments 52 to 56, wherein the asphalt mix exhibits a softening point of no greater than 265° F. or no greater than 260° F. or no greater than 255° F. or no greater than 250° F. or no greater than 245° F. or no greater than 240° F. or no greater than 235° F. or no greater than 230° F.

### Embodiment 58

The filled asphalt mix of any one of embodiments 52 to 57, wherein the asphalt mix exhibits a penetration at 77° F. of at least 4 dmm or at least 4.5 dmm or at least 5 dmm or at least 5.5 dmm or at least 6 dmm or at least 6.5 dmm or at least 7 dmm or at least 7.5 dmm or at least 8 dmm or at least 8.5 dmm or at least 9 dmm or at least 9.5 dmm or at least 10 dmm or at least 10.5 dmm or at least 11 dmm.

### Embodiment 59

The filled asphalt mix of any one of embodiments 52 to 58, wherein the asphalt mix exhibits a penetration at 77° F. of no greater than 20 dmm or no greater than 19 dmm or no greater than 18 dmm or no greater than 17 dmm or no greater than 16 dmm or no greater than 15 dmm or no greater than 14 dmm or no greater than 13 dmm or no greater than 12 dmm or no greater than 11 dmm or no greater than 10 dmm.

### Embodiment 60

The filled asphalt mix of any one of embodiments 52 to 59, wherein the asphalt mix exhibits a viscosity at 220° C. of at least 500 cP or at least 600 cP or at least 700 cP or at least 800 cP or at least 900 cP or at least 1000 cP.

### Embodiment 61

The filled asphalt mix of any one of embodiments 52 to 60, wherein the asphalt mix exhibits a viscosity at 220° C. of no greater than 2500 cP or no greater than 2250 cP or no greater than 2000 cP or no greater than 1750 cP or no greater than 1500 cP or no greater than 1250 cP.

### Embodiment 62

The filled asphalt mix of any one of embodiments 52 to 61, wherein the asphalt mix exhibits a viscosity at 200° C. of at least 1300 cP or at least 1400 cP or at least 1500 cP or at least 1600 cP or at least 1700 cP or at least 1800 cP or at least 1900 cP.

### Embodiment 63

The filled asphalt mix of any one of embodiments 52 to 62, wherein the asphalt mix exhibits a viscosity at 200° C. of no greater than 5000 cP or no greater than 4500 cP or no greater than 4000 cP or no greater than 3500 cP or no greater than 3000 cP or no greater than 2500 cP or no greater than 2000 cP.

### Embodiment 64

The filled asphalt mix of any one of embodiments 52 to 63, wherein the asphalt mix exhibits a viscosity at 180° C. of at least 1500 cP or at least 2000 cP or at least 2500 cP or at least 3000 cP or at least 3500 cP or at least 4000 cP.

### Embodiment 65

The filled asphalt mix of any one of embodiments 52 to 64, wherein the asphalt mix exhibits a viscosity at 180° C. of no greater than 15000 cP or no greater than 13000 cP or no greater than 11000 cP or no greater than 9000 cP or no greater than 7000 cP or no greater than 5000 cP.

### Embodiment 66

The filled asphalt mix of any one of embodiments 52 to 65, wherein the asphalt mix exhibits a viscosity at 160° C. of at least 8000 cP or at least 9000 cP or at least 10000 cP or at least 11000 cP or at least 12000 cP or at least 13000 cP or at least 14000 cP.

### Embodiment 67

The filled asphalt mix of any one of embodiments 52 to 66, wherein the asphalt mix exhibits a viscosity at 160° C. of no greater than 20000 cP or no greater than 19000 cP or no greater than 18000 cP or no greater than 17000 cP or no greater than 16000 cP or no greater than 15000 cP.

### Embodiment 68

A roofing shingle comprising:
a fiberglass mat;
an asphalt composition coating the fiberglass mat, the composition comprising the asphalt mix of any one of embodiments 52-67.

### Embodiment 69

A method of preparing an asphalt blend comprising:
mixing asphalt flux with an asphalt extender to form an asphalt blend.

### Embodiment 70

The method of embodiment 69, wherein the asphalt blend comprises the blend of any of embodiments 1-7.

### Embodiment 71

The method of embodiment 69 or embodiment 70, wherein mixing to prepare an asphalt blend is done at a temperature 325° F. or at least 330° F. or at least 345° F. or at least 350° F. or at least 355° F. or at least 360° F. or at least 365° F.

### Embodiment 72

The method of any one of embodiments 69 to 71, wherein mixing to prepare an asphalt blend is done at a temperature of no greater than 425° F. or no greater than 420° F. or no greater than 415° F. or no greater than 410° F. or no greater than 405° F. or no greater than 400° F. or no greater than 395° F. or no greater than 390° F. or no greater than 385° F.

### Embodiment 73

The method of any one of embodiments 69 to 72, further comprising oxidizing the asphalt blend to form an oxidized asphalt blend.

### Embodiment 74

The method of embodiment 73, wherein the asphalt blend comprises the blend of any of embodiments 8-26.

### Embodiment 75

The method of embodiment 73 or embodiment 74, further comprising mixing asphalt flux with the oxidized asphalt blend to prepare a modified asphalt blend.

### Embodiment 76

The method of embodiment 69, wherein the modified asphalt blend comprises the blend of any of embodiments 27-51.

### Embodiment 77

The method of embodiment 75 or embodiment 76, further comprising mixing a filler with the modified asphalt blend to form a filled mix.

### Embodiment 78

The method of embodiment 77, wherein the filled mix comprises the filled mix of any of embodiments 52-67.

### Embodiment 79

An asphalt blend comprising, overoxidized asphalt and asphalt flux.

### Embodiment 80

The asphalt blend of embodiment 79, wherein the blend comprises at least 50 wt. % overoxidized asphalt or at least 55 wt. % or at least 60 wt. % or at least 65 wt. % or at least 70 wt. % or at least 75 wt. % or at least 80 wt. % or at least 85 wt. % or at least 95 wt. %.

### Embodiment 81

The asphalt blend of embodiment 79 or embodiment 80, wherein the blend comprises no greater than 99 wt. % overoxidized asphalt or no greater than 98 wt. % or no greater than 97 wt. % or no greater than 96 wt. % or no greater than 95 wt. % or no greater than 94 wt. % or no greater than 93 wt. % or no greater than 92 wt. % or no greater than 91 wt. % or no greater than 90 wt. % overoxidized asphalt.

### Embodiment 82

The asphalt blend of any one of embodiments 79 to 81, wherein the blend comprises at least 1 wt. % asphalt flux or at least 2 wt. % or at least 3 wt. % or at least 4 wt. % or at least 5 wt. % or at least 6 wt. % or at least 7 wt. % or at least 8 wt. % or at least 9 wt. % or at least 10 wt. % asphalt flux.

### Embodiment 83

The asphalt blend of any one of embodiments 79 to 82, wherein the asphalt blend comprises a ratio of overoxidized asphalt to asphalt flux of at least 0.1 or at least 0.2 or at least 0.3 or at least 0.4 or at least 0.5 or at least 0.6 or at least 0.7 or at least 0.8 or at least or at least 0.9 or at least 1 or at least 2 or at least 3 or at least 4 or at least 5 or at least 6 or at least 7 or at least 8 or at least 9 or at least 10 or at least 12 or at least 14 or at least 16 or at least 18 or at least 20 or at least 22 or at least 25.

### Embodiment 84

The asphalt blend of any one of embodiments 79 to 83, wherein the asphalt blend comprises a ratio of overoxidized asphalt to asphalt flux of no greater than 10 or no greater than 9 or no greater than 8 or no greater than 7 or no greater than 6 or no greater than 5 or no greater than 4 or no greater than 3 or no greater than 2 or no greater than 1 or no greater than 0.9 or no greater than 0.8 or no greater than 0.7 or no greater than 0.6 or no greater than 0.5 or no greater than 0.4 or no greater than 0.3 or no greater than 0.2 or no greater than 0.1.

### Embodiment 85

The asphalt blend of any one of embodiments 79 to 84, wherein the blend comprises no greater than 50 wt. % asphalt flux or no greater than 45 wt. % or no greater than 40 wt. % or no greater than 35 wt. % or no greater than 30 wt. % or no greater than 25 wt. % or no greater than 20 wt. % or no greater than 15 wt. % or no greater than 10 wt. % asphalt flux.

### Embodiment 86

The asphalt blend of any one of embodiments 79 to 85, wherein the asphalt flux has a penetration at 77° F. of 140-400 dmm.

### Embodiment 87

The asphalt blend of any one of embodiments 79 to 86, wherein the overoxidized asphalt exhibits a softening point of at least 235° F. or at least 240° F. or at least 245° F.

### Embodiment 88

The asphalt blend of any one of embodiments 79 to 87, wherein the overoxidized asphalt exhibits a softening point of not greater than 300° F. or not greater than 290 OF or not greater than 280° F. or not greater than 270° F. or not greater than 260° F. or not greater than 255° F.

### Embodiment 89

The asphalt blend of any one of embodiments 79 to 88, wherein the overoxidized asphalt exhibits a penetration at 77° F. of at least 10 dmm or at least 11 dmm or at least 12 dmm or at least 13 dmm or at least 14 dmm or at least 15 dmm or at least 16 dmm.

### Embodiment 90

The asphalt blend of any one of embodiments 79 to 89, wherein the overoxidized asphalt exhibits a penetration at 77° F. of no greater than 30 dmm or no greater than 28 dmm or no greater than 26 dmm or no greater than 24 dmm or no greater than 22 dmm or no greater than 20 dmm.

### Embodiment 91

The asphalt blend of any one of embodiments 79 to 90, wherein the asphalt blend exhibits a viscosity at 200° C. of at least 250 cP or at least 300 cP or at least 350 cP or at least 400 cP or at least 450 cP or at least 500 cP or at least 550 cP.

### Embodiment 92

The asphalt blend of any one of embodiments 79 to 91, wherein the asphalt blend exhibits a viscosity at 200° C. of no greater than 1200 cP or no greater than 1100 cP or no greater than 1000 cP or no greater than 950 cP or no greater than 900 cP or no greater than 850 cP or no greater than 800 cP.

### Embodiment 93

The asphalt blend of any one of embodiments 79 to 92, wherein the asphalt blend exhibits a Heat absorption factor of at least 8750 J/g or at least 8800 J/g or at least 8850 J/g or at least 8900 J/g or at least 8950 J/g or at least 9000 J/g or at least 9050 J/g or at least 9100 J/g or at least 9150 J/g or at least 9200 J/g or at least 9250 J/g or at least 9300 J/g or at least 9350 J/g or at least 9400 J/g or at least 9500 J/g or at least 10000 J/g or at least 10500 J/g or at least 11000 J/g.

### Embodiment 94

The asphalt blend of any one of embodiments 79 to 93, wherein the asphalt blend exhibits a Heat absorption factor of no greater than 20000 J/g no greater than 19500 J/g no greater than 19000 J/g no greater than 18500 J/g no greater than 18000 J/g no greater than 17500 J/g no greater than 17000 J/g no greater than 16500 J/g no greater than 16000 J/g no greater than 15500 J/g no greater than 15000 J/g no greater than 14500 J/g no greater than 14000 J/g.

### Embodiment 95

The asphalt blend of any one of embodiments 79 to 94, wherein the asphalt blend exhibits a softening point of no greater than 235° F. or no greater than 230° F. or no greater than 225° F.

### Embodiment 96

The asphalt blend of any one of embodiments 79 to 95, wherein the asphalt blend exhibits a softening point of at least 190° F. or at least 195° F. or at least 200° F. or at least 205° F. or at least 210° F. or at least 215° F. or at least 220° F.

### Embodiment 97

The asphalt blend of any one of embodiments 79 to 96, wherein the asphalt blend exhibits a penetration at 77° F. of at least 15 dmm or at least 16 dmm or at least 17 dmm or at least 18 dmm or at least 19 dmm.

### Embodiment 98

The asphalt blend of any one of embodiments 79 to 97, wherein the asphalt blend exhibits a penetration at 77° F. of no greater than 30 dmm or no greater than 28 dmm or no greater than 26 dmm or no greater than 24 dmm or no greater than 22 dmm.

### Embodiment 99

A filled asphalt mix comprising the asphalt blend of any one of embodiments 79 to 98, further comprising a filler.

### Embodiment 100

The filled asphalt mix of embodiment 99, wherein the filler comprises limestone.

### Embodiment 101

The filled asphalt mix of embodiment 99 or embodiment 100, wherein the composition comprises a filler content of at least 40 wt. % filler relative to the weight of the asphalt blend or at least 42 wt. % or at least 44 wt. % or at least 46 wt. % or at least 48 wt. % or at least 50 wt. % or at least 52 wt. % or at least 54 wt. % or at least 56 wt. % or at least 58 wt. % or at least 60 wt. % or at least 61 wt. % or at least 62 wt. % or at least 63 wt. % or at least 64 wt. % or at least 65 wt. % or at least 66 wt. % or at least 67 wt. % or at least 68 wt. % or at least 69 wt. % or at least 70 wt. % or at least 71 wt. % or at least 72 wt. % or at least 73 wt. % or at least 74 wt. % or at least 75 wt. % or at least 76 wt. % or at least 77 wt. % or at least 78 wt. % or at least 79 wt. % or at least 80 wt. %.

### Embodiment 102

The filled asphalt mix of any one of embodiments 99 to 101, wherein the composition comprises a filler content of not greater than 90 wt. % filler for a total weight of the mix or not greater than 88 wt. % or not greater than 86 wt. % or not greater than 84 wt. % or not greater than 82 wt. % or not greater than 80 wt. % or not greater than 79 wt. % or not greater than 78 wt. % or not greater than 77 wt. % or not greater than 76 wt. % or not greater than 75 wt. % or not greater than 74 wt. % or not greater than 73 wt. % or not greater than 72 wt. % or not greater than 71 wt. % or not greater than 70 wt. % or not greater than 69 wt. % or not greater than 68 wt. % or not greater than 67 wt. % or not greater than 66 wt. % or not greater than 65 wt. % or not greater than 64 wt. % or not greater than 63 wt. % or not greater than 2 wt. % or not greater than 61 wt. % or not greater than 60 wt. %.

### Embodiment 103

A roofing shingle comprising:
a fiberglass mat;
an asphalt composition coating the fiberglass mat, the composition comprising the asphalt blend of any of embodiments 79 to 98 or the mix of any one of embodiments 99-102.

### Embodiment 104

A method of preparing an asphalt blend comprising oxidizing a first batch of asphalt flux resulting in an overoxidized asphalt, and mixing the overoxidized asphalt with second batch of asphalt flux resulting in an asphalt blend.

### Embodiment 105

The method of embodiment 104, wherein the asphalt blend comprises the blend of any of embodiments 79 to 98.

### Embodiment 106

The method of embodiment 104 or embodiment 105, wherein the mixing is done at a temperature of at least 325° F. or at least 330° F. or at least 345° F. or at least 350° F. or at least 355° F. or at least 360° F. or at least 365° F.

### Embodiment 107

The method of any one of embodiments 104 to 106, wherein mixing to prepare an asphalt blend is done at a temperature of no greater than 425° F. or no greater than 420 OF or no greater than 415° F. or no greater than 410° F. or no greater than 405° F. or no greater than 400° F. or no greater than 395° F. or no greater than 390° F. or no greater than 385° F.

### Embodiment 108

The method of any one of embodiments 104 to 107, wherein the first batch of asphalt flux and the second batch of asphalt flux are the same asphalt flux.

### Embodiment 109

The method of any one of embodiments 104 to 108, wherein the first batch of asphalt flux and the second batch of asphalt flux are the different asphalt fluxes.

### Embodiment 110

The method of any one of embodiments 104 to 109, wherein the first batch of asphalt flux has a penetration at 77° F. of 140-400 dmm.

### Embodiment 111

The method of any one of embodiments 104 to 110, wherein the first batch of asphalt flux has a penetration at 77° F. of 140-400 dmm.

### Embodiment 112

The method of any one of embodiments 104 to 111, further comprising mixing a filler with the asphalt blend to form a filled mix.

### Embodiment 113

The method of embodiment 112, wherein the filled mix comprises the filled mix of any of embodiments 99-102.

### EXAMPLES

### Example 1—Preparation of Unfilled Asphalt Compositions

Samples listed below in table 1 were prepared according to the following lab scale process. Sample S3C* was prepared according to an alternative, industrial scale process. Low pen asphalt flux (Penetration grade less than 200) was mixed with an asphalt extender to form an asphalt blend.

The asphalt blend then oxidized until the softening point reached a value between 20° and 212° F. Then additional low pen flux was added. Amounts of flux and extender can be found in Table 1.

TABLE 1

| | Oxidized | Overoxidized | | |
|---|---|---|---|---|
| | Asphalt | Asphalt | Extender | Asphalt Flux |
| Sample | (wt. %) | (wt. %) | (wt. %) | (wt. %) |
| CS1 | 97.5 | 0 | 2.5 | 0 |
| S1A | 95 | 0 | 2.5 | 2.5 |
| S1B | 92.5 | 0 | 2.5 | 5 |
| S1C | 90 | 0 | 2.5 | 7.5 |
| CS2 | 95 | 0 | 5 | 0 |
| S2A | 92.5 | 0 | 5 | 2.5 |
| S2B | 90 | 0 | 5 | 5 |
| S2C | 87.5 | 0 | 5 | 7.5 |
| CS3 | 93 | 0 | 7 | 0 |
| S3A | 88 | 0 | 7 | 5 |
| S3B | 87 | 0 | 7 | 6 |
| S3B* | 87 | 0 | 7 | 6 |
| S3C | 86 | 0 | 7 | 7 |
| CS4 | 90 | 0 | 10 | 0 |
| S4A | 87.5 | 0 | 10 | 5 |
| S4B | 85 | 0 | 10 | 6 |
| S4C | 82.5 | 0 | 10 | 7 |
| S5 | 0 | 90.73 | 0 | 9.27 |

Properties

| | SP | PEN @ 77° F. | Viscosity | | | | |
|---|---|---|---|---|---|---|---|
| Sample | (º F.) | (dmm) | 220° C. | 200° C. | 180° C. | 160° C. | 140° C. |
| CS1 | 205.0 | 15.2 | 250 | 600 | 1475 | 3550 | 22400 |
| S1A | 202.5 | 15.6 | 350 | 600 | 1375 | 4125 | 18650 |
| S1B | 200.5 | 15.7 | 225 | 500 | 1150 | 3725 | 16680 |
| S1C | 195.1 | 16.5 | 500 | 750 | 1275 | 3100 | 12700 |
| CS2 | 207.0 | 15.6 | 275 | 600 | 1575 | 5500 | |
| S2A | 203.0 | 16.0 | 450 | 775 | 1550 | 4600 | 21550 |
| S2B | 200.5 | 16.4 | 250 | 525 | 1300 | 4175 | 19550 |
| S2C | 197.2 | 17.3 | 250 | 475 | 1125 | 3500 | 15250 |
| CS3 | 204.4 | 17.3 | 275 | 575 | 1450 | 5075 | |
| S3A | 197.4 | 17.9 | 300 | 575 | 1200 | 3500 | 15100 |
| S3B | 196.5 | 19.5 | 275 | 500 | 1100 | 3400 | 15300 |
| S3B* | 201.2 | 18.7 | 350 | 675 | 1350 | 4000 | 17500 |
| S3C | 194.7 | 19.8 | 300 | 550 | 1100 | 3100 | 13250 |
| CS4 | 206.2 | 19.4 | 575 | 875 | 1700 | 5200 | |
| S4A | 199.2 | 20.7 | 325 | 600 | 1225 | 3625 | |
| S4B | 198.0 | 21.4 | 250 | 525 | 1025 | 3300 | |
| S4C | 197.1 | 22.2 | 225 | 500 | 1000 | 3000 | |
| S5 | 222 | 20 | | 585 | | | |

Softening point, Penetration, and viscosity were measured according to the test methods below in Table 2.

TABLE 2

| Test | ASTM Code | Test Name |
|---|---|---|
| Penetration | ASTM D5-06 | Standard Test Method for Penetration of Bituminous |
| | | Materials |
| Softening | ASTM | Standard Test Method for Softening Point of Asphalt and |
| Point | D3461-18 | Pitch (Mettler Cup-and-Ball Method) |
| Viscosity | ASTM | Standard Test Method for Viscosity Determination of Asphalt |
| | D4402-06 | at Elevated Temperatures Using a Rotational Viscometer |

A comparative sample CS5 was prepared by oxidizing asphalt flux until it had a softening point between 202 and 215° F.

An additional inventive sample, S5 was prepared by oxidizing asphalt flux (Penn at 77° F. of 340) to a high softening point of 250° F. The resulting oxidized asphalt also had a Pen at 77° F. of 17 dmm and a 1089 cPs viscosity at 200° C. The oxidized asphalt was then mixed with additional asphalt flux (Pen at 77° F. of 340). The resulting blend included 9.27% wt. % asphalt flux with the rest of the composition being oxidized asphalt. The resulting asphalt blend exhibited a softening point of 222° F., a Pen 77° F. of 20, and a viscosity of 585 cPs at 400° F.

### Example 2—Preparation of Filled Mixes

Filled asphalt mixes were prepared starting from asphalt compositions S3C* and S2D according to the following method and the details below in Table 3. Limestone was mixed into asphalt compositions at 110-130° C. Weights of limestone filler are relative to the weight of the asphalt composition and not the total mix including the filler.

TABLE 3

| Sample | Asphalt composition | Filler | SP | PEN @ 77 | Viscosity | | | | |
|---|---|---|---|---|---|---|---|---|---|
| | | | | OF | | | | | |
| | | content | (ºF) | (dmm) | 220 | 200 | 180 | 160 | 140 |
| | | | | | ° C. | ° C. | °° C. | | °° C. |
| S6 | S2D | 65 | 229.8 | 8.6 | 1750 | 4200 | 11450 | | |
| S7 | S3C* | 62 | 216.1 | 11.1 | 1075 | 1925 | 4600 | 14550 | |

Softening point, Penetration, and viscosity were measured according to the test methods above in Table 3.

### Example 3—DSC Testing

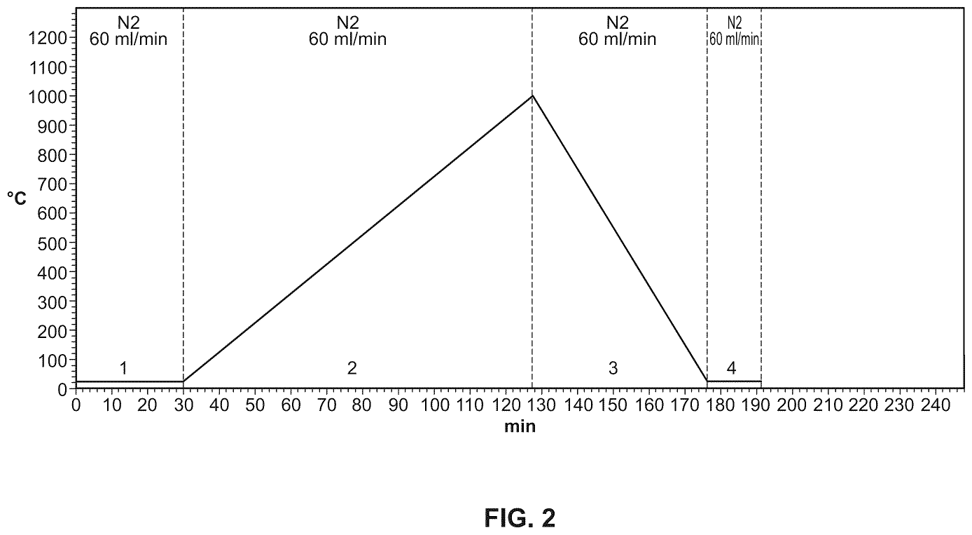

4-5 mg pellets of unfilled coating according to the samples above were isolated and placed in a clean μl alumina crucible. The sample is pressed into the bottom of the crucible to remove all air between the sample and crucible bottom. The samples underwent differential scanning calorimetry testing with a Mettler TGA-DSC 3+ using the parameters in Table 4 below and the temperature curve in FIG. 2.

TABLE 4

| | | Initial | Ramp | Tₘₐₓ | Holding |
|---|---|---|---|---|---|
| Instrument | Software | Isotherm | (K/min) | (° C.) | Isotherm |
| Mettler | STARe | 25° C./30 | 10 | 1000 | 1000 |
| TGA- | v19.00 | minutes | | | |
| DSC 3+ | | 60 mL/minute | | | |

DSC testing results can be found below in Table 5. A large negative number is indicative of an asphalt that undergoes endothermic processes when heated. This is believed to be beneficial for fire resistance and burning brand tests as the asphalt will absorb heat during the fire. The absolute value of the negative DSC test result may be referred to as a Heat absorption factor herein.

TABLE 5

| | | | | | Standard |
|---|---|---|---|---|---|
| Sample | Run 1 | Run 2 | Run 3 | Mean | Deviation |
| CS5 | −6033.41 (J/g) | −7085.49 (J/g) | −8664.01 (J/g) | −7260.97 (J/g) | 1081.08 (J/g) |
| SC3* | −9873.76 (J/g) | −9427.3 (J/g) | −10380 (J/g) | −9893.69 (J/g) | 389.19 (J/g) |
| S5 | −12904.71 (J/g) | −11817.27 (J/g) | −12277.03 (J/g) | −12333.00 (J/g) | 445.71 (J/g |

### Example 4—Burning Brand Test

Roof decks made from asphalt shingles prepared with the asphalt composition of sample S6 were evaluated according to burning brand test UL 790, and met the standards set by ASTM E108-28.

What is claimed is:

1. A modified oxidized asphalt blend comprising:
70-99.5 wt. % an oxidized asphalt;
0.5-20 wt. % of an oxidized asphalt extender; and
0.5-15 wt. % asphalt flux.

2. The asphalt blend of claim 1, wherein the asphalt extender comprises wax, vacuum tower asphalt extender, re-refined engine oil bottoms, bio-oil, process oil, or combinations thereof.

3. The modified oxidized asphalt blend of claim 1, wherein the modified oxidized asphalt blend exhibits a softening point of at least 175° F. and no greater than 250° F.

4. The modified oxidized asphalt blend of claim 1, wherein the modified oxidized asphalt blend exhibits a penetration at 77° F. of at least 12 dmm and no greater than 30 dmm.

5. The modified oxidized asphalt blend of claim 1, wherein the modified oxidized asphalt blend exhibits a Heat absorption factor of at least 8750 J/g and no greater than 20000 J/g.

6. A filled asphalt mix comprising the asphalt blend of claim 1, and further comprising a filler.

7. A roofing shingle comprising:
a fiberglass mat;
an asphalt composition coating the fiberglass mat, the composition comprising the asphalt mix of claim 6.

8. An asphalt blend comprising overoxidized asphalt and asphalt flux.

9. The asphalt blend of claim 8, wherein the asphalt blend comprises a ratio of overoxidized asphalt to asphalt flux of at least 0.1 and no greater than 10.

10. The asphalt blend of claim 8, wherein the overoxidized asphalt exhibits a softening point of at least 235° F.

11. The asphalt blend of claim 8, wherein the asphalt blend exhibits a Heat absorption factor of at least 8750 J/g and no greater than 20000 J/g.

12. The asphalt blend of claim 8, wherein the asphalt blend exhibits a softening point of at least 190° F. no greater than 250° F.

13. The asphalt blend of claim 8, wherein the asphalt blend exhibits a penetration at 77° F. of at least 10 dmm and no greater than 30 dmm.

14. A filled asphalt mix comprising the asphalt blend of claim 8, and further comprising a filler.

15. A roofing shingle comprising:
a fiberglass mat;
an asphalt composition coating the fiberglass mat, the composition comprising the asphalt mix of claim 14.

16. An asphalt blend exhibiting a Heat absorption factor of at least 8750 J/g and no greater than 20000 J/g.

17. The asphalt blend of claim 16, wherein the asphalt blend exhibits a penetration at 77° F. of at least 10 dmm and no greater than 30 dmm.

18. The asphalt blend of claim 16, wherein the asphalt blend exhibits a softening point of at least 175° F. and no greater than 250° F.

19. A filled asphalt mix comprising the asphalt blend of claim 16, and further comprising a filler.

20. A roofing shingle comprising:
a fiberglass mat;
an asphalt composition coating the fiberglass mat, the composition comprising the asphalt mix of claim 19.
